(19) United States
(12) Patent Application Publication
(10) Pub. No.: US 2001/0037581 A1
(43) Pub. Date: Nov. 8, 2001

(54) Measurement device of the type of a compass, particularly for use in medical technology

(76) Inventors: Soheyl Akhavan-Sigari, Gottingen (DE); Sasan Harun-Mahdavi, Munchen (DE)

Correspondence Address: HELFGOTT & KARAS, P.C., 60TH FLOOR, EMPIRE STATE BUILDING, NEW YORK, NY, 10118-6098, US

(21) Appl. No.: 09/767,883

(22) Filed: Jan. 23, 2001

Related U.S. Application Data
(63) Continuation of application No. PCT/EP99/05367, filed on Jul. 27, 1999.

(30) Foreign Application Priority Data
Jul. 27, 1998 (DE) 19833685.3

(51) Int. Cl. G01B 3/16; G01B 3/56

(52) U.S. Cl. 33/807; 33/534; 33/471; 33/558.01

(57) ABSTRACT

The invention relates to a measuring device comprising two rod elements which can be pivoted about a common axis of rotation and form the sides of an angle and whose angular positions towards each other can be detected electronically. The device also comprises a calculator which in accordance with a set angle calculates the distances along straight or curved lines extending between the points defined by the rod elements, as well as a display unit which displays the set angle or the distances detected. Said measuring device can also be used as electronic calculator.

The invention relates to a measurement device of the type of a compass, with two shanks that can be pivoted around a common axis of rotation, the angular position of which, in each instance, can be electronically acquired and read off to measure the length between the tips of the shanks or to measure the angle formed by the shanks, using a digital display unit, particularly for use in medical technology.

In dental medicine, manual compasses to measure distances are known. Using a related measurement ruler, it is possible to determine lengths and angles, in order to obtain from them relevant data for the assessment of values measured on the patient, on models, or using X-ray images. This known method involves a significant expenditure of time; in addition, significant inaccuracies cannot be precluded when working with such compasses and measurement rulers.

A measurement device of the type stated initially is known from the German Offenlegungsschrift 4422721. Such a dental angle setter detects the change in angle by way of electronic angle transmitters. The angle value is displayed digitally. For correct positioning of the device, it is necessary to clamp it into an attachment adapter, and this is a complicated procedure.

In contrast, the present invention is based on the task of creating a universal measurement device of the type of a compass, of the type stated initially, which is particularly well suited for use in medical technology; for this purpose, it can be used freely, i.e. independent of clamping devices; it is supposed to be characterized, in particular, by simple handling and rapid evaluation of the measurement values obtained.

A measurement device according to the invention, with these characteristics, comprises two shanks that can be pivoted around a common axis of rotation, the angular position of which, relative to one another, in each instance, can be electronically acquired and read off to measure the angle formed by the shanks, using a digital display unit, particularly for use in medical technology.

In this connection, in accordance with a concrete embodiment, the axis of rotation is formed by a pivot bearing that comprises two concentric bushings; each bushing is connected with only one of the two shanks, and the pivot bearing is contained in a housing that has not only the display unit but also an electronic computer unit for assessing the measurement data.

The computer unit is programmed in such a way that for each shank position, the angle enclosed between the shanks and, optionally, also the distance between the tips, can be read off on the display unit.

In a further development, the computer unit comprises a memory unit for interim storage and/or further processing of the measurement data according to a user program, and this ensures that the measured data are secured and can be processed further in accordance with the user program, e.g. according to the four basic types of calculations.

The measurement device according to the invention can also be used like a usual electronic computer, where two rod elements that can be pivoted relative to one another and form angle shanks, the angular position of which, relative to one another, can be electronically acquired, are provided to input calculation values, that the signals generated in this way form calculation values that correspond to the angle adjusted in each instance, and that additional calculation values are formed from distances between the rod elements, with reference to a set angle and defined distance end points on the rod elements, in each instance. In this connection, the number of digits of the calculation values can be selected to be different, and the decimal point can be set as desired, for example using a key.

In addition to their function to activate the computer, it is advantageous if the rod elements are formed as rulers that end in a tip that lies in the plane of the contact surface. It is preferable that the rulers are made from a transparent material and possess scale markings. Therefore the computer is very particularly suitable for use in schools, as a combined calculation and drawing instrument.

In a further development of the invention, it is provided that the computer unit is provided with an interface to an external data processing system. In this way, the measurement data can also be used in more complex data processing programs, and more comprehensive records can be created.

A preferred location for electronically acquiring the angular position between the two shanks is brought about in that the relative pivot position of the two bushings relative to one another is scanned. This can be done using a usual potentiometer; however, inductive, capacitative, electro-optical or magnetic angle transmitters are also possible.

The pivot bearing with the two bushings is preferably located in a housing in which the ends of the shanks that are at a distance from the tips are located. Such a housing can be made in one part and be connected with one of the two bushings. It can also be structured as a two-part housing, each part of which is connected with one of the bushings or the other. In this connection, the shanks are each connected with one bushing or with one housing part, preferably in releasable manner. The releasable connection can be structured as a plug-in connection. In this way, the shank parts with the tips can be easily removed and sterilized, if they are used for medicinal purposes.

Arranging the plug-in connection inside the housing guarantees that patients will not come into contact with non-sterile parts of the measurement device. The housing itself can be packaged in a sheath made of a transparent, sterile film, for this purpose.

To simplify handling of the measurement device, it is provided, according to another further development, that the shanks are held in a spread-apart basic position by means of a spring arranged in the housing. For use in dental medicine, this basic position can be reached, for example, at an angle of 120°. For larger angles of spread, finger-type catches that project outward approximately perpendicular to the axis of rotation are provided on the shanks. It is preferable that these are structured so that they can be pivoted to rest against the shanks or to enter into a recess in them.

If the measurement device is not being used, the shanks, folded together, with their tips going first, can be inserted into a cap that serves as a tip protector and, at the same time, prevents injuries.

The mathematical shank length is preferably up to 20 cm; the maximum shank opening is preferably 180°. For measurements on the patient, the shanks have a blunt end; for measurements of X-ray images or measurements on models, it is preferable to use shanks with sharp ends.

For ergonometric reasons, it is practical that the housing is structured as a flat body, the outline of which is shaped, on an outside segment that lies opposite the shank tips, to fit a holding position between the thumb and forefinger. For this purpose, the outside segment of the housing can describe approximately an arc; such a housing is easier to produce than an oval housing, although the latter fits better into the fold of skin between the thumb and forefinger.

In order to improve the hold in the holding position, it is provided that the lateral circumference surface of the housing is shaped in groove form towards the inside, at least in the outside region of the housing, so that it engages in the said fold of skin.

In order for the housing to always maintain a central position between the shanks, a guide device that centers the two shanks, as it is also found in usual compasses, can be provided.

When measuring flat articles, such as X-ray images, it is practical that the housing is provided on one side with a contact surface for taking measurements on a flat surface, which describes a plane with the correspondingly bent tips of the shanks.

A secure measurement position of the measurement device can be achieved in that the housing has a continuous viewing window in the region around the axis of rotation. In this way, the person taking the measurement can look through the entire housing and therefore align the measurement device with a specific peak point of the object. The said viewing window is preferably located within the said contact surface. An attachment clip can be provided either on the housing, on the side of the contact surface, or on the cap in which the two shank tips are held.

The design of the display and operation unit housed in the housing is essential for practical use of the measurement device according to the invention. Accordingly, an operation unit with activation keys for switching the device on and off, selecting the measurement units and the calculation operation, or for data transfer into the memory, are provided in the housing. In addition, of course, the housing contains a battery compartment for operation of the computer unit, which is closed with a screw-on cover.

When a first measurement value is stored in memory using an “enter” key, it can subsequently be subjected to a calculation operation previously entered by activating the “mode” key, along with another measurement value, etc. In this connection, the four basic calculation types, which are needed both for medical applications and when the measurement device is used as a pocket calculator, are practical. Preferably, the measurement device is in a blank state whenever it is turned on, i.e. all of the values measured or calculated up to that time were deleted the last time the device was shut off.

The measurement device according to the invention is suitable not only for uses in dental medicine; shank lengths that amount to as much as 20 cm also allow its use in gnathic orthopedics, e.g. to determine the facial length index, in prosthetics, for example to determine the patient's vocal distance and bite height, to measure birthmarks in dermatology, to measure angles in orthopedics, or to measure reference lengths and distances in facial surgery.

In the following, exemplary embodiments of the invention will be explained using the drawing. This shows:

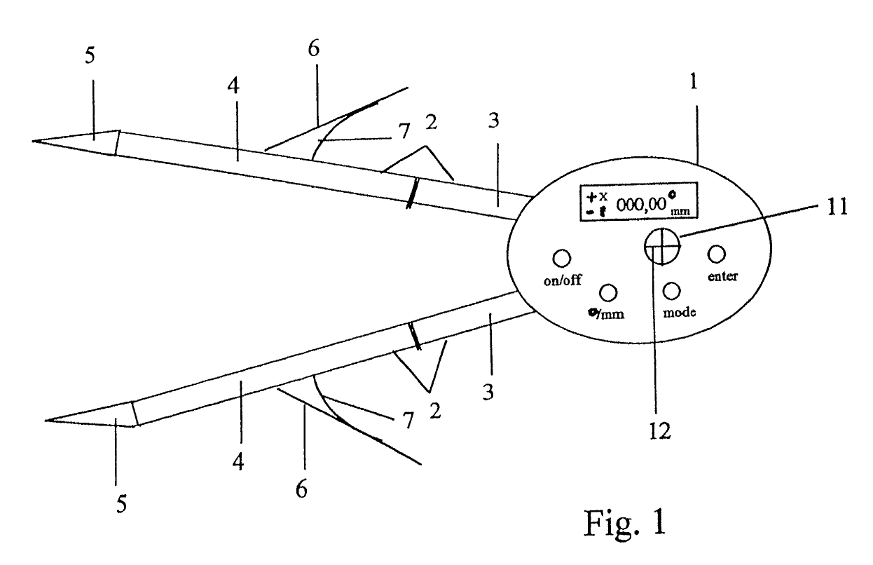

FIG. 1 a schematic top view of the measurement device according to the invention,

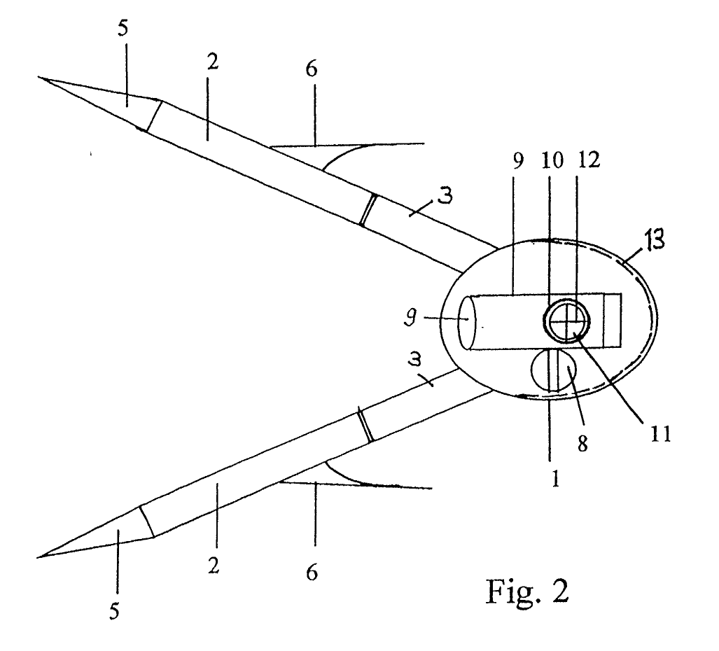

FIG. 2 a view of the device from below,

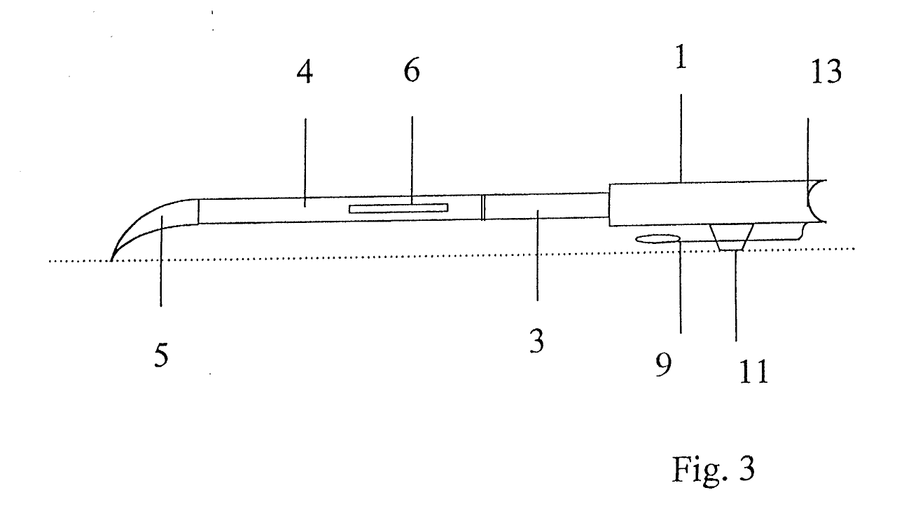

FIG. 3 a side view of the device,

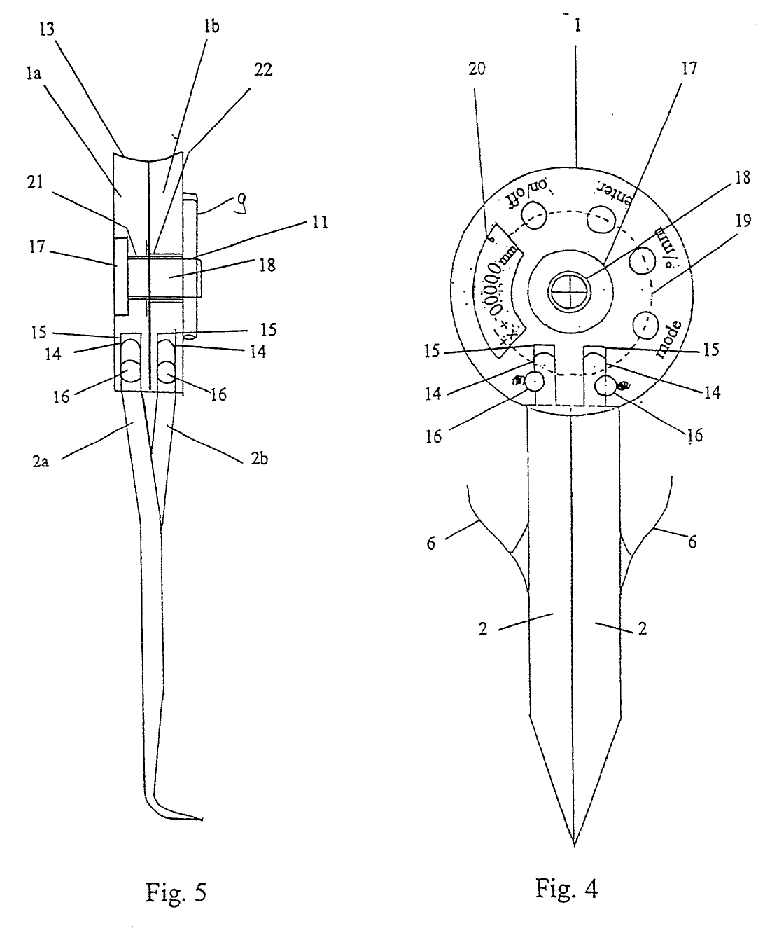

FIG. 4 another embodiment in a top view,

FIG. 5 the embodiment according to FIG. 4 in a side view,

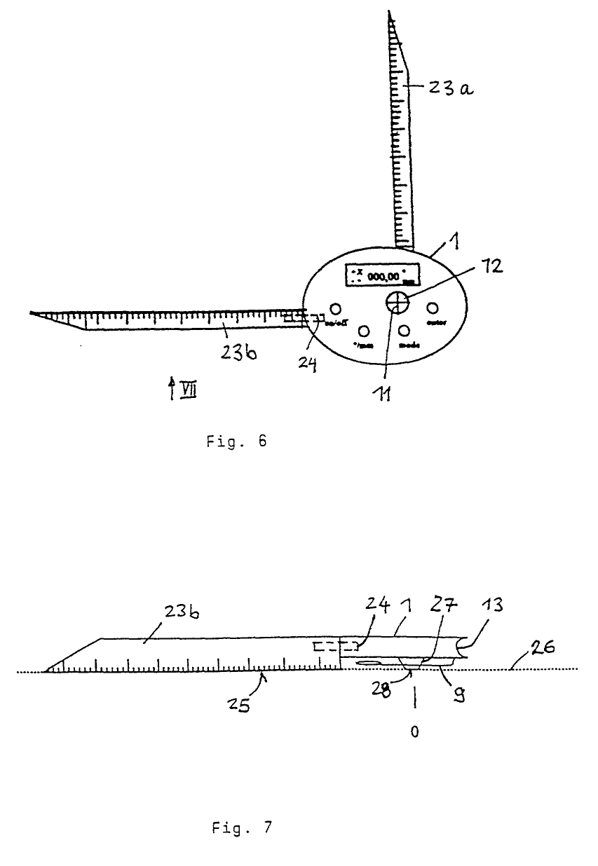

FIG. 6 a top view of an embodiment with rulers, and

FIG. 7 a side view to go along with FIG. 6, in accordance with the arrow VII.

According to the embodiment of the measurement device according to FIGS. 1 to 3, it possesses a housing 1 at the peak point of the shanks 2, at the top of which keys to activate the computer unit housed in it are arranged.

The “on/off” key relates to shutting the computer on or off; the measurement unit shown on the display is selected using the “°/mm” key; the “mode” key allows a selection of one of the four basic types of calculation, as displayed on the display, namely +, −, ×, and ÷. The “enter” key allows the measurement value displayed on the display, which can be indicated to a total of five digits, to be stored in memory.

In its center, the housing 1 has a viewing window 11 with cross hairs 12, so that the mathematical axis of the shank adjustment can be brought into precise agreement with a corresponding marking on a surface under it. The viewing window 11 is structured not as a simple opening or aperture, but rather covered with transparent covers on both sides, in order to prevent contamination.

Two shank stumps 3 are attached, inside the housing, to bushings (not shown) that can be rotated relative to one another. Releasable shank parts 4 with tips 5 are seated at their free ends. In the region of the releasable shank parts 4, finger-type catches 6 are provided, which are set to project outward, using spreading spring 7. When they are not in use, the finger-type catches 6 can be pressed against the shank parts 4, where they remain in this position by means of a stop catch (not shown).

In the view of the housing 1 from below according to FIG. 2, a screw-down lid 8 for a battery compartment, as well as a spring-mounted clip part 9 with a cut-out 10 for the viewing window 11, which has cross hairs 12 adjacent to the bottom, can be seen.

In the side view according to FIG. 3, the concave structure of the outside segment of the housing 1, which is structured as a one-part housing here, can be seen. When the measurement device is in use, the fold of skin formed between the forefinger and thumb enters into the circumference groove 13 formed in this way, so that the measurement device finds a secure hold there.

According to FIG. 3, the tips are structured to be sharp, and curved in the direction towards the back, so that the ends of the tips lie in a plane with the contact surface of the viewing window 11. Shanks structured in this way are particularly suitable for measurement work on a flat surface, e.g. when measuring X-ray images. For measurement work from a greater distance, the tips can be replaced with laser pointers. In addition, one or both shanks can be provided with a level.

In the embodiment according to FIG. 4 and 5, the housing 1 is horizontally divided into a top housing part 1a and a bottom housing part 1b. One shank 2 is attached in the top housing part 1a, with a connection end 2a that is shaped towards the top, the other shank 2 is attached in the bottom housing part 2b, with a connection end 2b that is shaped towards the bottom. For this purpose, the connection ends 2a, 2b have rectangular alignment pins 14, with which they enter into the corresponding housing sleeves 15, where they are held in place by means of spring-loaded ball catches 16. The two shanks each have a blunt tip bent downward, which is suitable for taking measurements on a patient. A continuous viewing window 11 is also provided in this embodiment. It is composed of a pane part 17 and a tube part 18. The tube part 18 sits within a bushing 21, which is connected with the top housing part 1a. An outer bushing 22 concentrically surrounds the inner bushing 21. The outer bushing 22 is connected with the bottom housing part 1b.

Here, the various activation keys are arranged along a circular line 19, in the top housing part 1a; this also holds true for the display, whose window 20 describes an arc.

FIGS. 6 and 7 show a development as a calculation and drawing device, particularly for school purposes. The two shanks are formed by rulers 23a, 23b that can be plugged in, with their plug-in connection being made clear by pegs 24. The side view according to FIG. 7 shows that the rulers 23a, 23b possess flat contact sides 25, and each end with a tip in the plane of the contact sides 25.

According to FIG. 7, the rulers 23a, 23b therefore rest completely on a contact surface 26. In this connection, the peak point “0” of the angle formed between the rulers 23a, 23b can be simply and accurately set using the cross hairs 11 [sic] in the viewing window 12 [sic]. For this purpose, it is helpful that the viewing window 12 [sic] is arranged in a housing projection 27, the face 28 of which also rests on the contact surface 26.

1. Electronic computer device with a display device and several calculation functions, in which two rod elements that can be pivoted relative to one another and form angular shanks are provided to input calculation values, where their angular position relative to one another can be electronically acquired, in such a way that the signals generated in this way form calculation values that correspond to the angle set in each instance,
in which additional calculation values are formed and can be set based on distances between the rod elements, in each instance with reference to a set angle and defined distance end points on the rod elements, and
which has activation keys for storing the measurement value (°/mm) displayed on the display in memory (enter), for selecting basic types of calculations (mode), as well as a main switch (on/off).

2. Computer device according to claim 1,
characterized in that
the rod elements are structured as rulers (23a, 23b) that end with a tip that lies in the plane of their contact sides (25).

3. Computer device according to claim 2,
characterized in that
the rulers (23a, 23b) each have a scale marking on their bottom inside surface, on the edge adjacent to the contact surfaces (25), facing the other ruler.

4. Computer device according to claim 2,
characterized in that
the inside and contact surfaces (25) of the rulers (23a, 23b) are structured to be flat to the tip.

5. Computer device according to claim 1,
characterized in that
in the region of the geometric pivot axis of the rod elements, it is structured so that one can see through it, and is provided with an axis marking.

6. Measurement device of the type of a compass, with two shanks (2) that can be pivoted around a common axis of rotation, the angular position of which, relative to one another, in each instance, can be electronically acquired and read off to measure the length between the tips (5) of the shanks (2) or to measure the angle formed by the shanks (2), using a digital display unit, particularly for use in medical technology,
characterized in that
the axis of rotation is formed by a pivot bearing that comprises two concentric bushings,
that each bushing is connected, directly or indirectly, with only one of the two shanks (2), and
that the pivot bearing is contained in a housing (1) that has not only the display unit but also an electronic computer unit for assessing the measurement data.

7. Measurement device according to claim 6,
characterized in that
the computer unit comprises a memory unit for interim storage and/or further processing of the measurement data according to a user program.

8. Measurement device according to claim 6,
characterized in that
the computer unit is provided with an interface to an external data processing system.

9. Measurement device according to claim 6,
characterized in that
the housing (1) is formed in one part and is connected with one of the two bushings.

10. Measurement device according to claim 6,
characterized in that
the housing (1) is formed in two parts, the parts (1a, 1b) of which are each connected with one bushing (21, 22).

11. Measurement device according to claim 9 or 10,
characterized in that
the shanks (2) are releasably connected either directly with a bushing or with a housing part (1a, 1b).

12. Measurement device according to claim 11,
characterized in that
the releasable connection is structured as a plug-in connection.

13. Measurement device according to claim 6,
characterized in that
the shanks (2) are held in a spread-apart basic position by means of a spring arranged in the housing (1).

14. Measurement device according to claim 6,
characterized in that
the shanks (2) have finger-type catches (6) that project outward approximately perpendicular to the axis of rotation.

15. Measurement device according to claim 14,
characterized in that
the finger-type catches (6) can be pivoted to rest against the shanks or to enter into a recess in them, counter to the force of a spring (7).

16. Measurement device according to claim 14,
characterized in that
the finger-type catches (6) are arranged to be adjustable in the lengthwise direction of the shanks.

17. Measurement device according to claim 6,
characterized in that
an operation unit with activation keys for switching the device on and off, selecting the calculation units and the calculation operation, or for data transfer into the memory, are provided in the housing (1).

18. Measurement device according to claim 6,
characterized in that
the housing (1) is structured as a flat body, the outline of which is shaped, on an outside segment that lies opposite the shank tips, to fit a holding position between the thumb and forefinger.

19. Measurement device according to claim 18,
characterized in that
the outside segment of the housing (1) describes approximately an arc.

20. Measurement device according to claim 18,
characterized in that
the outside segment of the housing (1) is shaped as an oval, when it is a one-part housing.

21. Measurement device according to claim 18,
characterized in that
the lateral circumference surface of the housing (1) is shaped in groove form towards the inside, at least in its outside region.

22. Measurement device according to claim 18,
characterized in that
the housing (1) is provided, on one side, with a contact surface for conducting measurements on a flat surface, which describes a plane with the tips (5) of the shanks (2).

23. Measurement device according to claim 18,
characterized in that
the housing (1) has a continuous viewing window (11) in the region around the axis of rotation.
